(19) United States
(12) Patent Application Publication
(10) Pub. No.: US 2014/0278981 A1
(43) Pub. Date: Sep. 18, 2014

(54) AUTOMATED ALLOCATION OF MEDIA VIA NETWORK

(71) Applicants: Gueorgui Mersov, Toronto (CA); James Shanahan, San Francisco, CA (US); Vince Prevost, Toronto (CA); Yuanyi Pan, North York (CA); Alan Steven Levine, Toronto (CA)

(72) Inventors: Gueorgui Mersov, Toronto (CA); James Shanahan, San Francisco, CA (US); Vince Prevost, Toronto (CA); Yuanyi Pan, North York (CA); Alan Steven Levine, Toronto (CA)

(21) Appl. No.: 14/350,017

(22) PCT Filed: Oct. 6, 2012
(86) PCT No.: PCT/US12/59153

§ 371 Date: Apr. 4, 2014

Related U.S. Application Data
(60) Provisional application No. 61/544,134, filed on Oct. 6, 2011.

(51) Int. Cl. G06Q 30/02

(52) U.S. Cl. CPC G06Q 30/0275; G06Q 30/0255
USPC 705/14.53

(57) ABSTRACT

There are provided systems and methods for allocation of digital media over communication networks. A bidding platform for digital advertising manages multichannel buying of digital media using impression-level decisioning based on multiple parameters and data sources. When a request for an ad is received from a publisher or other supply side entity, such as an ad exchange or supply side platform, an expected value of the advertisement impression to each advertiser is calculated, in some cases, in real time, on behalf of the advertiser using media-buying rules. An ad having a highest expected value is selected, and the bidding platform responds to the ad request with a bid and the selected ad, and serves the winning ad if bid response wins the publisher side auction, resulting in an ad impression for the winning ad. User interactions with the ad are recorded and leveraged to optimize further the media buying rules.

### TECHNICAL FIELD

The disclosure relates generally to automated allocation of media via network and, more specifically, to allocation and delivery of media content in a cost-optimized fashion based on probabilitistic modeling of historical target behaviour.

### BACKGROUND

Digital advertising is a form of promotion that uses the Internet, World Wide Web, or apps for the purpose of delivering marketing messages or other digital content in order to attract customers to a product or service. In a networked environment, such as the Internet, digital advertising typically involves a formal relationship between advertiser and publisher, whereby a publisher (who is otherwise unrelated to the advertiser) provides or allocates portions of a webpage or apps, which are commonly referred to as “ad slots”, for advertising purposes. The advertiser then pays the publisher for the right to display media content, such as an ad, in the allocated ad slot on a per view or a per impression basis. Each time an advertisement or other digital content or media is displayed in an ad slot may be referred to herein as an “impression”. Typically, an advertiser pays the publisher a price for each ad impression that in some way correlates to an expected value or return, e.g., resulting from purchase of a product featured in the ad, which the advertiser will receive from the content being viewed by a customer. Impressions that result in action by the customer are sometimes referred to as “conversions”.

Accordingly, digital advertising involves both a supply side and a demand side market economy. Demand in this context refers to how much (quantity) of ad slot inventory is desired by advertisers, and may be measured in terms of impressions; supply represents the number of impressions publishers are willing to make available at a certain price. Viewed in this example context, advertisers can be considered demand-side entities and publishers supply-side entities. Demand side is often referred to alternatively as buy-side, and supply-side can be referred to as sell-side. Impressions may be made available to advertisers via a direct relationship with the publisher (e.g., a publisher of web pages or applications on mobile communication devices such as smart phones, tablet computers, or other digital devices, whether mobile or otherwise) or, alternatively, through intermediaries such as supply side platforms, or advertising exchanges. Advertisers interested in impressions may be individuals, companies, or other organizations, which moreover may be further represented in terms of an agency or demand side systems, such as ad networks and demand side platforms (DSPs).

As the volume of available impressions continues to increase, advertisers and underlying supply chains—today's digital media buyers—whether working in an agency environment or inside a company's marketing department, face increasing levels of complexity in developing, managing, optimizing, and reporting on their media programs. It would therefore be advantageous to have improved systems and methods for managing multi-channel buying and execution and thereby improve current workflows.

At the same time as the volume of available impressions continues to increase, advertising inventory is more commonly being made available for purchase in a real-time bidded (RTB) fashion. Accordingly, it would further be advantageous to provide a bidding platform (e.g., a demand-side platform) that dynamically identifies available advertising inventory and generates cost-optimized media buying rules for such inventory by taking into account multiple context variables about the inventory in a real-time manner. Such bidding platforms may then bid on identified inventory through an auction process, and ultimately purchase this won inventory on a first price or second price auction basis.

### SUMMARY

Embodiments of the invention relate to a bidding platform for digital advertising that delivers cost-optimized digital advertising on behalf of advertisers or their representatives, such as agencies. Such embodiments provide a system for managing multi-channel buying of digital media using impression-level decisioning based on multiple parameters and data sources. When a request for an ad comes from a publisher or a publisher's agent, such as an ad exchange or supply side platform, the system computes the expected value of the advertisement impression to advertiser, in real time, and on behalf of the advertiser using media-buying rules, and then selects an ad with the highest expected value for delivery, responds to the ad request with a bid and the selected ad, and serves the winning ad if the bid response wins the publisher-side auction, resulting in an ad impression for the winning ad. User interaction with the ad is then recorded in a log file, which can be leveraged for further optimization of media buying rules.

A bidding platform according to the disclosure may provide one or more of the following features either individually or in combination. In some embodiments, the bidding platform may be operable to create and/or manage an advertising campaign or multiple campaigns on behalf of an advertiser or an advertiser's surrogate. In some embodiments, the bidding platform may collect campaign data, user behavior data, advertiser data, and publisher data. This data may be augmented and combined with first party data (e.g., private advertiser data such as offline store sales data), second party data (e.g., private co-op data from strategic partners), and third party data (e.g., data vendors such as BlueKai, Experian, Exelate, TargusInfo). In some embodiments, the bidding platform may setup and manually manage media buying rules yielding manual bidding. In some embodiments, the bidding platform may optimize media buying rules for an automatic bidder. In some embodiments, the bidding platform may generate and deploy a bidder service that provides an interface to match buyer demand to supplier supply by matching against the inventory of impressions. In some embodiments, the bidding platform may provide a user interface to manage the bidder service. In some embodiments, the bidding platform may integrate with and interface to multiple exchanges in order to provide access to a cross exchange spectrum of disparate and different supply sources. In some embodiments, the bidding platform may integrate with and interface to third party ad servers for ad management, reporting on performance, and/or operations. In some embodiments, the bidding platform may calculate daily impression estimates for multiple exchanges and campaigns. In some embodiments, the bidding platform may provide reporting of performance of an ad campaign across a cross exchange spectrum of suppliers. In some embodiments, the bidding platform may provide pacing mechanisms whereby the distribution of impressions for an ad over time can determined programmatically or manually.

Accordingly, in at least one broad aspect, there is provided a system for generating data representing parameters useful for causing a processor to identify content to be displayed on a graphical user interface. Such system may comprise the same or another processor and stored machine-readable instructions configured to cause the processor to: parse stored data to identify input patterns associated with a plurality of historical user interactions with displayed content on input/output interfaces, the stored data representing one or more attributes of the plurality of historical user interactions, and the identified input patterns defined in terms of two or more correlated variables; based at least partly on the identified input patterns, generate data useful in implementing one or more media buying rules useful on a bidding platform for obtaining authorization to provide selected display content data to one or more client systems requesting the same or other selected content for display; and route the generated data useful in implementing the one or more media buying rules to a bid generation engine associated with the bidding platform.

In at least one other broad aspect, there is provided a method of generating data representing parameters useful for causing a processor to identify content to be displayed on a graphical user interface. The method may be implemented by the same or another processor executing stored machine-readable instructions, and may include: parsing stored data to identify input patterns associated with a plurality of historical user interactions with displayed content on input/output interfaces, the stored data representing one or more attributes of the plurality of historical user interactions, and the identified input patterns defined in terms of two or more correlated variables; based at least partly on the identified input patterns, generating data useful in implementing one or more media buying rules useful on a bidding platform for obtaining authorization to provide selected display content data to one or more client systems requesting the same or other selected content for display; and routing the generated data useful in implementing the one or more media buying rules to a bid generation engine associated with the bidding platform.

In at least one other broad aspect, there is provided a computer readable medium or media on which are stored instructions that, when executed a processor, program the processor to perform a method of generating data representing parameters useful for causing the same or another processor to identify content to be displayed on a graphical user interface. The method may include: parsing stored data to identify input patterns associated with a plurality of historical user interactions with displayed content on input/output interfaces, the stored data representing one or more attributes of the plurality of historical user interactions, and the identified input patterns defined in terms of two or more correlated variables; based at least partly on the identified input patterns, generating data useful in implementing one or more media buying rules useful on a bidding platform for obtaining authorization to provide selected display content data to one or more client systems requesting the same or other selected content for display; and routing the generated data useful in implementing the one or more media buying rules to a bid generation engine associated with the bidding platform.

Further details of these and other aspects of the described embodiments will be apparent from the detailed description below.

### BRIEF DESCRIPTION OF THE DRAWINGS

Reference is now made to the accompanying drawings, in which:

FIG. 1 shows an example network environment;

FIG. 2 shows an example environment for allocating content over communication network architectures;

FIG. 3 shows an example information flow within the content allocation environment of FIG. 2;

FIG. 4 shows an example embodiment of a bidding platform included in the environment of FIGS. 2 and 3;

FIG. 5 shows an example data log record;

FIG. 6 shows an example embodiment of a bid optimizer included in the bidding platform of FIG. 4;

FIG. 7 shows an example process performed by a feature selector included in the bid optimizer of FIG. 6;

FIG. 8 shows an example table that illustrates the process shown in FIG. 7;

FIG. 9 shows an example distribution of a permuted test statistic;

FIG. 10 shows an example process performed by a rules generator included in the bid optimizer of FIG. 6;

FIG. 11 shows an example table that illustrates the process shown in FIG. 10;

FIG. 12 shows an example process performed by a bid calculator included in the bid optimizer of FIG. 6;

FIG. 13 shows an example table that illustrates the process shown in FIG. 12; and

FIG. 14 shows an example process performed by a bid refiner included in the bid optimizer of FIG. 6.

### DETAILED DESCRIPTION OF THE PREFERRED EMBODIMENTS

Various embodiments, including at least one preferred embodiment, are described below with reference to the drawings.

Reference is initially made to FIG. 1, which illustrates an example network environment 100 comprising a plurality of client devices 102 coupled to a plurality of servers 104 over a communication network 106. Client devices 102 may generally be any network-enabled devices, such as local machines, desktop or portable computers, smart phones or other mobile or cellular devices, which are operable to request networked resources from servers 104 over the communication network 106.

Servers 104 may include any remote machines or nodes that host or serve content to client devices 102. For example, servers 104 may include any file server, application server, web server, proxy server, appliance, network appliance, gateway, gateway, gateway server, virtualization server, deployment server, SSL VPN server, or firewall. In some embodiments, servers 106 may function as web servers that provide requested content to client devices 102 using any suitably configured communication protocol. For example, servers 104 may provide content to client devices 102 across a network interface. In some embodiments, client devices 102 may access one or more different application programs running on servers 104.

Communication network 106 may comprise any suitable network infrastructure that provides wired or wireless data communication between client devices 102 and servers 104. For example, communication network 106 may be any suitable type or configuration of a local-area network (LAN), such as an enterprise or home intranet. Alternatively, communication network 106 may be any suitable type or configuration of a wide area network (WAN), such as the Internet (referred to sometimes as the “World Wide Web”. In still further embodiments, communication network 106 may be any suitable type of wireless local area network (WLAN), such as a wireless “hot spot”, or a wireless wide area network (WWAN), including any presently existing or future adopted cellular network technologies, such as AMPS, TDMA, CDMA, GSM, GPRS or UMTS. Without limitation (unless specifically dictated by context) communication network 106 may comprise any suitable public or private network across which data may be communicated, for example, including a point-to-point network, a broadcast network, a wide area network, a local area network, a telecommunications network, a data communication network, a computer network, and the like.

Online publishers, including servers 104, may allocate areas or portions of their displayed content for advertising to client devices 102. In some cases, such online publishers may define these advertising areas or portions so as to be differentiable from other areas created and displayed by the publishers for their own content. For example, such advertising areas may include any form or type of space or region on a web page hosted by servers 104 over communication network 106, and which may overlap with or reside within other displayed content on the web page. Without limitation, this may include locations for banners, ad blocks, sponsored listings, side margin ads, flash displays, pop-up pages, mouse-over animations, and others.

In some embodiments, advertising or other media displayed by servers 104 may be negotiated directly between advertisers and media publishers (e.g., servers 104) and application (app) publishers, whether device or web-based. For example, an entity that wishes to advertise a product or service to target recipients (e.g., users of client devices 102) may directly engage media publishers for the right to publish content on their web pages. Thus, separate arrangements may be made between the advertiser and the media publishers.

However, in some embodiments, advertisers may utilize one or more ad networks and exchanges 108, which provide a platform through which a plurality of different publishers may offer advertising space to plural advertisers simultaneously. Thus, ad networks and exchanges 108 may consolidate the sale and purchase of a plurality of different advertising opportunities by matching an advertising opportunity offered by a seller (i.e., a publisher) to a purchaser (i.e., an advertiser). Examples of ad networks and exchanges 108 included Google AdX, Yahoo Right Media, AppNexus, and others.

Different ad networks and exchanges 108 may provide different advertising opportunities to target recipients, and in some cases on different terms, than do other ad networks and exchanges 108. Thus, a single ad network or exchange 108 may only provide a limited number of advertising opportunities to a potential purchaser, and not necessarily on favourable terms. In some cases, each different ad network or exchange 108 may also implement different, potentially proprietary, processes for brokering transactions between publishers and advertisers. Such differences may relate to the types and/or specification of advertising related information, terms and/or parameters.

In some embodiments, a bidding platform 110 that is accessible over communication network 106 may provide a common interface for advertisers and publishers to access multiple ad networks and exchanges 108. For example, bidding platform 110 may allow an advertiser to bid for advertising opportunities simultaneously on multiple different ad networks and exchanges 108 through a common information exchange protocol. An advertiser using bidding platform 110 does not thereby have to negotiate the different proprietary processes of each ad network or exchange 108 in order to make multiple different bids across plural ad networks or exchanges 108.

While a particular network environment 100 is shown in FIG. 1 by way of example only, different variations and alternations may be apparent and/or suggested within the context of the disclosure. For example, the numbers and configurations of client devices 102, servers 104, ad networks and exchanges 108, and bidding platform 110 are not generally limited (any specific number shown in FIG. 1 is for convenience and clarity of illustration only). Additionally, network connections between devices other than are provided by communication network 106 may be provided. For example, additional client devices (not shown) may be connected to servers 106 through one or more secondary communication networks, as may be typical in an enterprise network environment. Still other network devices not explicitly shown in example network environment 100 may also be included.

Ad networks and exchanges 108 and bidding platform 110 have also each been described in the context of advertising opportunities for convenience, but may in general relate to any network-enabled devices that provide opportunities for display of media and other content by content providers to intended recipients. Thus, embodiments of network environment 100 are not limited only to advertising opportunities, although in particular applications, network environment 100 may be particularly suited to delivering advertising content to client devices 102. Opportunities to deliver such content may be referred to herein throughout as “impression opportunities”, which may include, but not be limited to, opportunities for advertising products, services, or businesses that are not directly provided by or related to the publishers of the displayed content.

Referring now to FIG. 2, there is shown an example environment 200 useful for allocating content over communication network architectures. The example environment 200 may facilitate real-time bidding and/or auctioning of ad impressions offered to advertisers by publishers, as well as batch purchase and sale. Both buy side and sell side entities are shown.

In the example environment 200, a demand side platform 205 may provide one or more different buy side entities with access to impressions offered by one or more different sell side entities. For example, an advertiser 235 may either directly or through an intermediary, such as an agent 230, ad server 225 or ad network 220, use a demand side platform 205 to create and manage an advertising campaign. As explained further below, such advertisers 235 may supply different campaign constraints and/or objectives to demand side platform 205, which may then translate the constraints and/or objectives into media buying rules for ad impressions originating from the supply side.

On the sell side, a supply-side platform 225 may be configured and operated so that one or more different sell side entities can solicit requests for bids on different ad impression opportunities. Thus, a consumer 285 or a publisher 280 who has network resources available for allocation of content provided by an advertiser 235 may use supply-side platform 225 to send out ad calls to different interested buy-side entities. Publishers 280 may interface with supply-side platform 225 directly or through one or more intermediaries, such as ad servers 275 or ad networks 270.

In some embodiments, the relationship between demand and supply side can be modular, so that any entity generally may, in some cases, be able to work with a plurality of other entities at the same level or otherwise within a digital advertising environment. For example, an advertiser may in some cases engage directly with a (plurality of) publisher(s) and/or with any subset of intermediaries. Alternatively, an advertiser may engage directly with ad exchange (s) having no direct relationship with publisher(s)), or an advertiser may engage with an ad agency that works directly with ad exchange(s).

As shown in FIG. 2, a demand side platform 205 and a supply side platform 255 may interface with each other in order to facilitate the exchange of bid requests and bid responses. For example, demand-side platform 205 may include a buy side client that is used by advertisers 235 or their agents to interface with a sell side server in supply side platform 255. To exchange requests and bids on ad impressions, demand side platform 205 may include a bidder service that is communicatively linked with an auction service on the supply side platform 255. Additionally, one or more data managers 240 and one or more data brokers 290 may be provided to organize and manage information flow between the buy and side, such as user behavior data, advertiser data, and publisher data. This information may be augmented by and/or combined with first party data (e.g., private advertiser data such as offline store sales data), second party data (e.g., private coop data from strategic partners), and/or third party data (e.g., data vendors such as BlueKai, Experian, Exelate, TargusInfo).

Referring now to FIG. 3, there is shown an example information flow within the example environment 200 shown in FIG. 2 whereby an advertiser (or its agent) is able to create and manage an advertising campaign in terms of constraints and objectives, and which is cost-optimized by a bidding platform operating based on data logs of historical user interaction data, first party data, second party data, and/or third party data. An campaign can be associated with multiple ad creatives, which may be provided to fill different ad slot constraints, (e.g., based on size, or media type (video versus banner versus text, black and white versus color, etc.). In addition, a given campaign may be part of a hierarchy of other campaigns whereby various campaign information and/or statistical data may be shared between different campaigns within the hierarchy for targeting and/or optimization purposes.

As seen in FIG. 3, advertisers or their agents 235 may create and manage an advertising campaign in terms of constraints and objectives, which may subsequently be translated into media buying rules that are used by a bidding service within a bidding platform 210, which responds to ad calls from a publisher 280 or a publisher's agent, such as an ad exchange 250 or supply side platform requesting a bid(s) and corresponding ad(s). When the bidding platform 205 receives a request for an ad bid, bidding platform 205 may calculate an expected value to each advertiser 235 of the advertisement impression, in real time, on behalf of the advertiser 235 using media-buying rules. Bidding platform 205 may then select the ad having the highest expected value, i.e., bid, and respond to the ad request with a bid response containing a bid and the selected ad, or a pointer to the selected ad. In some embodiments, a plurality of highest bids and corresponding ad payloads may be incorporated a bid response generated by bidding platform 205. If the generated bid wins the publisher side auction conducted by ad exchanges 250, ad servers 225,275 may serve the winning ad to client devices 295, resulting in an ad impression for the winning ad being made on consumers 285 operating the client devices 295. The interaction of a consumer 285 to a particular impression is then logged by the ad server 227,275 that served the winning ad. Accordingly, the users' interactions with the served ads may be recorded in log files, e.g., via tracking services such as cookies and beacons, which can then be provided back to bidding platform 205 wherein they may be leveraged so as to optimize further the media buying rules. Typically, the ad serving workflow is triggered by a user, e.g., consumers 285, interacting with a publisher webpage or app on client devices 295, thereby leading to an ad call from such publishers 280

When a campaign is initially set up by an advertiser 235, various different attributes (sometimes referred to as constraints) of the campaign may be manually determined. Such constraints may include bid price, campaign duration, schedule, budget, and targeting. One generally recognized objective of an advertising campaign is to identify a well-defined target market or target audience, e.g., potential customers. Targeting can be user-centric, target page-centric, a hybrid of user- and target page-centric, or left unspecified. For example, in the case of user-centric constraints, the intent and preferences (e.g., user preference for luxury items) of the customer 285 reading a target webpage on client devices 295 can be leveraged and used so as to locate users/consumers 285 interested in particular product or service (e.g., a user browsing a newly released luxury car might be interested in purchasing a luxury car; this behaviour can be leveraged to target this user, as opposed to other potential customers, with ads for luxury cars).

Target markets are groups of people separated by distinguishable and noticeable aspects. For example, target markets can be specified using any or each of the following segmentation parameters (or others) either individually or in combination: geographic (user's location), demographic or socio-economic (gender, age, income occupation, education, sexual orientation, household size, and stage in the family life cycle), psychographic (similar attitudes, values, and lifestyles), behavioral (occasions, degree of loyalty), product-related (relationship to a product). Additionally, lists of keywords (a subset of these keywords need to be present in the target page or the profile of the user being target), category lists (websites, webpages, users), domain lists, sub-domain lists, URL lists, and others can be used to define target markets. Moreover, regular expressions corresponding to the above may also be used to specify partial matching, or a more flexible means of specifying constraints. Other constraints such as retargeting objectives (e.g., users who have already been exposed to an impression), frequency capping whereby a ad is only exposed to the user a limited number of times over a specified time period, e.g., 3 times per day, and any combination of the above or other differentiators may be used in embodiments.

An advertiser 235 may specify one or more constraints using a graphical user interface or programmatically via an application program interface (API), which characterize target online media or target online audience and ad campaign objectives and constraints. In some cases, an advertiser 235 or the advertiser's representative (e.g., customer services division, sales personnel, or an account manager of the demand side organization) specifies the target constraints to a bidding platform 205 using the language of the bidding platform 205. In some cases, this language may need to be translated to match the language of the impression and data supplier suppliers. Such translations may be setup manually or automatically determined. For example, a bid request may present an impression opportunity in terms of page-level categories from a third party taxonomy; these categories could be used either as is or, in some case, could be mapped to local taxonomy of categories for category normalization purposes. Such mapping could be manually compiled or automatically generated by techniques from, e.g., the field of natural language processing. Campaign constraints can be viewed in different mathematical terms, such as: lists of items (e.g., categories of webpages, intents of consumers, etc.); numerical (e.g., local temperature); and ordinal (e.g., age group of consumer). Moreover, constraints can be either hard (e.g., have to be exactly matched) or soft (e.g., matched approximately in terms of regular expressions, or need not be matched).

Campaign constraints supplied to a bidding platform 205 can sometimes be initially broad and explorative in nature and possibly sub-optimal (in terms of key performance indicators such as conversion rates). A campaign manager can also expresses campaign limits (e.g., budget and the time period to flight the ad campaign) and objectives (e.g., targeted cost per transaction, total spend, total revenue generated, etc.). Campaign constraints and objectives can be provided to a bidding platform 205 once or on a continual and updated basis, as needed.

Campaign constraints and/or objectives can be expressed using variables and associated values to denote different categories or qualities. In this manner, campaign constraints and/or objectives can be used in a bidding platform 205 to generate an initial campaign bidder to bid on media impressions offered by a supply side entity, which may include a set of media buying rules (sometimes referred to as scenarios), for example, of the following form:

If [symbol] CONDITIONS [symbol] , then [symbol] BID [symbol] , (1)

where CONDITIONS represent a context in which a BID will be made. For example, a media buying rule may take the form of:

$$If 〈 \begin{matrix}Gender = Male \\ Age = 18 - 30 \\ PublisherSourceCategory = News\end{matrix} 〉 , then 〈 Bid = \$1 .10 〉 . \qquad ( 2 )$$

In the example shown in equation (2), the selected variables include Gender, Age, and the topic-based category of the publisher sources. The values given to these variables are male (or female), 18 to 30 years old (or some other age group), and news (or sports, fashion, arts, travel, etc.). As explained in more detail below, the bid value may be calculated so as to expose customers 285 fitting this scenario or description with ad impressions predicted to be of interest, and in which the ad impressions are purchased in cost-optimized fashion according to media-buying rules of the example type shown above.

Media buying rules can be generated by taking the cross product of variable values. For example, if 3 constraint variables have been defined, each constraint being binary valued (i.e., with only 2 unique values), the cross product of this variable set will result in eight (2×2×2) possible bidding rules. The CONDITIONS component of the media buying rule may be generated based upon this cross product operation. The BID component of a media buying rule may be defined as a function of the cost an advertiser 235 is willing to pay for the ad impressions, as explained further below, which may involve predictive user behavioural models that are generated from training sets comprising datalogs of past user historical behaviour or responses to ad impressions, as well as first party data, second party data, and/or third party data as described herein.

Advertiser cost can be expressed using one or more suitable cost models, such as a cost per impression (CPM) business model, whereby an advertiser bids a rate that will be paid for each impression, sometimes aggregated to 1000 (M in “CPM”). Alternatively, advertisers 235 may employ a cost per click (CPC) model, which is sometimes also referred to as pay per click (PPC). Alternatively, a cost per action (CPA) model may also be used, which is sometimes known as pay per action (PPA), whereby an advertiser 235 pays for each specified action (e.g., a purchase of a product, a lead form submission for a loan) linked to the advertisement.

A bid price for a media buying rule can be defined differently according to which advertiser cost model is adopted. For example, when a campaign payment model is CPM-based, bid price may be defined as follows:

$$Bid = \frac{1}{1000} \times CPM \times ( 1 - Margin ) \qquad ( 3 )$$

where margin denotes a defined profit margin being charged by a demand side service, e.g., bidding platform 205, for managing and trafficking the particular campaign. Because advertisers 235 pay per impression in this cost model regardless of customer response to the ad impression, bid price is not explicitly defined in terms of performance considerations, such as an action rate (defined in terms of clicks, downloads, purchases, etc.).

However, a bid price for a media buying rule can alternatively be defined using performance based pricing models, such as CPC or CPA, whereby performance is based upon the click rate (which can be defined as the number of clicks generated when customers 285 are exposed to this ad impression divided by number of impressions of the ad) or some other suitable action rate. For convenience, these types of actions (clicks, downloads, purchase, etc.) may be referred to herein as conversions.

Accordingly, in some embodiments, a bid price for a media buying rule that involves conversion based pricing models can be defined as follows:

Bid=P(action|p,a,u)×CPC×(1−Margin) (4)

where P(action|p, a, u) represents a predicted conversion rate (e.g., a quality score in search engines) for an ad a displayed to a user u in a particular digital context, such as a webpage or app (application) p. Accordingly, parameters p, a, and u denote an overall context for the ad impression in terms of the target page (where the ad is shown), characteristics of the ad itself, and the user 285 that is exposed to the ad impression, respectively. In equation (4), CPC represents the bid price that the advertiser 235 has agreed to pay bidding platform 205 for each action (as opposed to impression) on this ad in the case of a first price auction; in the case of second price auctions this bid corresponds to the maximum price an advertiser 235 or its agent will pay for an action of on this ad impression. The product of conversion rate and cost per action therefore provides an estimate of cost (to advertiser 235) per impression, which thereby also may fix limits on a maximum bid price (either with or without margin) that a bidding platform 205 will bid to an ad exchange 250 in response to a bid request. Conversion rate can be any probability or real-valued score.

For performance-based campaigns, predicted conversion rate P(action|p, a, u) for an impression can be computed, at least initially, based upon historical user behaviour from other (concurrent or past) advertising campaigns or other formed expectations. In order to determine such past historical user behaviour, one or more log files containing data records that record the outcome of customer interactions with ad impressions in different exposed contexts can be logged (e.g., by ad servers 225,275) and stored in a suitable database within biding platform 205. Such data records can then be analyzed by bid optimization routine(s) in bidding platform 205 in order to identify different scenarios or contexts, and expected conversion rates for ad impressions given those contexts recorded in the logged data sets. Based upon this historical data (also sometimes referred to as a training data set), predicted conversion rates P(action|p, a, u) for future or recently initiated campaigns can be generated. Such conversion rates can be computed initially based upon expectation, but then be adjusted with additional impression log files collected during the ad campaign as individual ads get impressions.

After generation of media buying rules, a campaign can be uploaded and deployed to a bidding server within bidding platform 205 to begin actively bidding for ad impressions on exchanges 250. In some cases, bids may be generated by bidding platform 205 and delivered to exchanges 250, in real time, in response to requests for bids (RFBs) on ad calls received at exchanges 250 from publishers 280 or other supply side entities. Accordingly, after receiving (RFBs) from a supply side agent, such as an exchange 250, a bidding platform 205 may match campaign media buying rule(s) to a given impression, select an ad (or other content) to form the impression based upon one or more ranking criteria, such as highest bid price (of match ad campaigns), and then send a bid response (e.g., a bid) to the exchange 250 containing information relating to the bid price(s) and/or information (pointer or actual ad creative) about the ad(s) to be exposed should the bid be successful.

Bidding platform 205 can (and may typically will) respond to RFBs in a real time manner (typically measured in milliseconds) on a bid-by-bid basis as bid requests are received from ad exchanges 250. However, in alternative embodiments, bidding platform 205 may deliver bid responses in a non-real time manner, such as in batches. In still further embodiments, bidding platform 205 may deliver bid responses to publishers 280 directly in order to acquire ad impressions on client devices 295. While FIG. 3 may illustrate one possible embodiment of a bidding environment 200 that may usefully generate real-time bids on ad exchanges, such other arrangements for bidding on and delivering content to client devices 295 are within the scope of the described embodiments as well.

When an auction for an impression has been completed and a winning bid generated, an ad exchange 250 may then deliver the winning ad or other content to client device(s) 295 in accordance with the originating ad call (e.g., which is generated when client devices 295 request access to publisher content, such as a website or webpage or app authored by publisher 280). For example, an ad exchange 250 may send a request message to an ad server 225,275 or network instructing such entity(ies) to serve the winning ad to a client device 295. An ad server 225,275 may in some cases be a computer server, for example, a web server, which stores and delivers advertisements or other content in response to ad requests received from, e.g., ad exchanges 250. Additionally, an ad server 225,275 may perform other tasks, such as logging and/or counting the number of impressions/clicks/actions for an ad campaign and report generation, which may b useful in determining a return on investment for an advertiser 235 on a particular website.

Accordingly, if a bid response sent to an exchange 250 by a bidding platform 205 is successful, an ad server 225,275 may be contacted by the bid requestor or its proxy for the ad creative (image, text, video, etc.) corresponding to the winning ad campaign. The ad server 225,275 then may respond with the winning creative and log the impression. For example, the following items maybe logged:

request_begin_time string, ad_id string, impression_id string, page string,
user_agent string, user_cookie string, ip_address string, clicked boolean

Once content is delivered to a client device 295, a user 285 of the device registers the impression and interacts therewith according to one or another outcome or action, such as click-through, or by no interaction at all (e.g., no action). Each user response to an impression may be logged by an ad server 225,275, and also on the client side in the form of a cookie. For example, the items logged may include:

request_begin_time string, ad_id string, impression_id string, page string,
user_agent string, user_cookie string, ip_address string, clicked boolean

Log files sent from client devices 295 to ad servers 225,275 containing impression and/or response information may be complied and transmitted to a bidding platform 205 for analysis and use in generation of media buying rules having predictive capability of future user responses to impressions.

In some cases, a bid request sent by an exchange 250 to a bidding platform 205 may contain information about an impression (or possibly multiple impressions), which can be described by collection of features or variables. For example, the information may sometimes be characterized by a tuple <m, s, p, a, u> where m denotes information about the impression itself (time, day of week etc.); s denotes features about the source of the impression (e.g., exchange identifier, % of won impressions from source, etc.), p denotes features related to the target page (app, web page, etc.), where the impression is located, e.g., domain name, category of webpage, App name etc; a denotes features about the ad, e.g., size of the ad, terminology in the ad text, forbidden categories of ads etc.; and u denotes features about the user, e.g., location of user, web browser type, interests of user (derived from, say, user search and browser behavior) etc. Impression features or variables can be supplied by publishers 280, exchanges 250, advertisers 235 or their agents, as well as other data providers.

Having received a bid request of this form, for example, bidding platform 205 may process the impression related variables included in the bid request in order to match values for the variables with all valid (have budget and satisfies other targeting constraints, such as geography, time of day, etc.) campaign-level rules so as to select which media buying rule(s) to apply. All valid ad campaigns (possibly corresponding to multiple advertisers or their agents) may in some cases be considered in generating a bid response. In some cases, media buying rules can be sorted in decreasing order of their bid prices or other suitable ranking feature. The ad campaign associated with the media buying rule having the highest bid or rank can be selected as the winning campaign, and a corresponding bid response object is generated, communicated to the bid requester, e.g., exchange, and logged. The bid response object is a function of the winning bid and information about the winning ad (creative and related redirects).

In some embodiments, a plurality of highest ranking bids and corresponding ads may combined to produce a bid response. The bid requester subsequently may receive the bid response objects generated in this manner, and conduct an auction as between the various bid responses (from other parties) and assign the impression to a submitter of a bid response with the highest bid. The accept bid may be either the cost of the winning bid if a first price auction is being conducted by the bid requester or, alternatively, in some cases, at the cost of the second highest bid if a second price auction is being conducted. The type and/or semantics of the auction may be defined and controlled by the bid requestor and agreed upon by both the demand and supply side entities.

Bidding rules for ad campaigns may be stored in a computationally efficient manner in order to generate fast responses to bid requests received from exchanges 250. For example, in some cases, ad exchanges 250 may require a bidding platform to generate responses within timeframes on the order of 10 milliseconds and, moreover, with minimal storage requirements. Accordingly, in some embodiments, a bidding platform 205 can store media buying rules in an inverted index data structure (which can exploit the sparse nature of bidding rules in the sense that not all variables or features may be present in each media buying rule) and a supporting administrative data structure. The supporting administrative data structure, for example, may be a hashtable structure for storing and accessing the bid and other administrative information associated with each media buying rule.

Within this example framework, bidding rules can be represented in terms of conditions and bids, e.g., as indicated above in equations (1) and (2). The conditions component of media buying rules correspond to the features or the characteristics of the impression and ad campaign, and can be stored for high-speed access using an inverted index. An inverted index is an index data structure storing a key-value mapping where the key corresponds to rule features (such as Age (20-30), Geo (San Francisco)), and the value corresponds to a list of rules where these conditions occur. An example of an inverted index structure for bidding rule conditions is shown in the table below, in which media buy rule conditions are the keys into the table, and are associated with values in the form of a list of media buying rules where the corresponding condition(s) occur.

| Feature Condition | Media Buying Rule IDs |
|---|---|
| Age (20-30) | 1, 3, 4, 5 |
| TargetPageCategory(Business) | 1, 2, 3, 4 |
| Geography(TMA) | 5 |
| DayOfWeek(Saturday) | 1, 7 |

In some cases, an inverted index may be effectively used to allow fast matching of impression conditions with corresponding media buying rules. However, increased processing time when new media buying rules are added to the database may be a trade-off for such speed increase. The value associated with each key is generally referred to as the postings list. In this case, it could be a (linked) list of posting records. A posting record could be simply a rule identifier denoting that this condition occurred or is associated with this rule and a corresponding payload; the payload is often left blank in the case of a rule bidder. A posting is formally represented as a tuple <RuleID,Payload>, where RuleID is the media buying rule identifier (generally ranges from 1 to the number of unique media buying rules N), and Payload (which is left blank. For efficiency of memory usage and query scoring time, each posting list can be sorted in increasing order of Rule ID.

In some embodiments, a media buying rules inverted index can be created as follows. A unique RuleID (rule identifier) can be assigned to each of the M media buying rules. In some cases, rule identifiers can be assigned such that media buying rules for all ad campaigns managed by a bidding platform 205 are sorted in decreasing order of bid, and in increasing order of the number of conditions associated with a media buying rule. The first rule in a list ordered this way can be assigned a rule identifier of 1, so on down to the last rule in this sorted list, which is assigned an identifier M. Each condition present in a media buying rule can then be extracted as one or more tuples of the form: <Condition, RuleID>, e.g., so that a rule with three conditions generates three corresponding tuples of this form.

The set of all tuples <Condition, RuleID> that are generated can then be sorted alphabetically based on the condition as well as numerically based on RuleID. Thus, all the same conditions can be grouped together and sorted in increasing order of RuleID within each Condition. Such sorted list of tuples <Condition, RuleID> can then be processed to produce a list of RuleIDs for each condition, i.e., Condition: {Rule1, Rule2, Rule5}. This corresponds to producing the postings list for each media buying rule condition.

Since rule identifiers within each of the postings list are sorted in increasing order, numerous ways to encode postings lists in such manner that memory requirements are reduced may be possible. For example, in some embodiments, the postings list could be encoded using a strategy such as run-length encoding. Alternatively, the inverted index structure can be implemented as a hash table or binary tree.

In some embodiments, the supporting administrative data structure, referred to as the admin table, may be a hashtable where the key corresponds to the bidding rule identifier and the corresponding value is a tuple of the form: <number of conditions, media buy active, bid, campaignID, AdId, other rule related information>, where number of conditions denotes the number of conditions in the bidding rule; media buy active denotes whether a media buying rule is still active (may not be active due to budget expiration, or pacing restrictions, etc.); campaignID denotes the campaign associated with this media buying rule. An example of such an admin table is provided below:

| | Num. | | Ad | |
|---|---|---|---|---|
| Rule | Conditions | Active | Campaign ID | Bid |
| 1 | 3 | yes | 20 | $0.01 |
| 2 | 1 | yes | 20 | $0.01 |
| 3 | 2 | no | 30 | $0.005 |
| 4 | 2 | yes | 40 | $0.005 |
| 5 | 2 | no | 30 | $0.005 |
| 6 | 1 | yes | 20 | $0.005 |
| 7 | 1 | yes | 30 | $0.0035 |

With an inverted index created as described herein, such index can be used to match campaign media buying rules with impressions. For example, a set of impression features X₁, . . . , X_{N} can be used to access the posting lists PL1, . . . , PLN associated with each of the impression features via random access. Given the selected set of posting lists, a position pointer is set for each posting list, P1, . . . , PN. Each of the selected posting lists is scanned from the beginning with each pointer being forwarded until all pointers point to the same Rule ID or until the end of a posting list is reached for one or more of the selected posting lists. This scan exploits the order of the rule ids (sorted in increasing order) to speed up this pointer synchronization step. If the end of one or more posting lists is reached as a result of this process then no media buying rules match the impression. However, if after scanning, a rule id is found then this corresponds to a media buying rule matching the impression.

In some embodiments, the Rule ID of the matching rule is used to directly access the admin table to verify some conditions: does the number of conditions in the media rule correspond to the number of features associated with the impression; is the media buying rule active. If both conditions are true then a bid response object is generated using the bid price associated with the rule along with the campaign id associated with the winning rule.

In some embodiments, this scan and verify process may be repeated where all or a subset of matching rules are selected, their corresponding bids are then used as weights in a roulette wheel-based selection process, i.e., randomly select a media buying rule where the roulette wheel is weighted in proportion to the bid associated with each rule. This subset could be limited to the top N media buying rules or to the rules with the same highest bid, for example.

In some embodiments, this scan and verify process can be stopped early by the following stopping condition: if on a successful scan the number of conditions associated with the rule under verification is less than the number of impression conditions then this current rule does not match the impression conditions and no other rules will match the impression so the postings scan can be terminated.

Using the example of the inverted index and admin table above, seven different media buying rules are defined by values for four different conditions (ie., Age, TargetPageCategory, Geography, and DayOfWeek). For example, Rule 1 has the following form:

$$If 〈 \begin{matrix}Age = 20 - 30 \\ TargetPageCategory = Business \\ DayOfWeek = Saturday\end{matrix} 〉 , then 〈 Bid = \$0 .01 〉 . \qquad ( 5 )$$

Thus, an incoming bid request from an ad exchange 250 with associated impression data of Age=20-30, TargetPageCategory=Business, and DayOfWeek=Saturday would yield a media matching rule set consisting of {Rule 1} and corresponding bid of $0.01. Bidding platform 205 would then send a bid response with this bid information included and information about the ad creative associated with this campaign ID 20 that satisfies the creative constraints (e.g. size, media type etc.).

In an alternative embodiment, the postings list associated with each condition may be organized as follows. The corresponding rules may be grouped together based on the number of rule conditions and, within each group, rules are sorted in decreasing order of bid. The posting list now becomes a list of rule lists (e.g., a list of postings), which can be stored as a hash table, in which the key is the number of conditions and associated value is a list of rules that have that number of conditions sorted in decreasing order of bid.

With an inverted index created as described herein, such index can be used to match campaign media buying rules with impressions. For example, a set of impression features X₁, . . . , X_{N} can be used to access the posting lists PL1, . . . , PLN associated with each of the impression features via random access. Then within each posting list, the subposting list corresponding to the number of impression features, N, can be accessed directly (using a hashtable). This results in a set of N shorter posting lists. Given the selected set of shorter posting lists, a position pointer is set for each posting list, P1, . . . , PN. Each of the selected posting lists is scanned from the beginning with each pointer being forwarded until all pointers point to the same Rule ID or until the end of a posting list is reached for one or more of the selected posting lists. This scan exploits the order of the rule ids (sorted in increasing order) to speed up this pointer synchronization step.

If the end of one or more posting lists is reached as a result of this process then no media buying rules match the impression. However, if after scanning, a rule id is found then this corresponds to a media buying rule matching the impression. In some embodiments, the Rule ID of the matching rule is used to directly access the admin table to verify some conditions: is the media buying rule active. If this condition is true then a bid response object is generated using the bid price associated with the rule along with the campaign id associated with the winning rule. These steps can be repeated to find other match rules if the bid response object is to be made up of multiple bids.

Referring now to FIG. 4, there is shown an example embodiment of a bidding platform 205 shown in FIG. 3. Bidding platform 205 may be implemented using suitable software programs, hardware components, firmware components, or any combinations thereof, which are or may be configured using any presently existing or future developed computing technologies. Such computing components providing a bidding platform 110 may be implemented on a network-enabled server device.

For example, bidding platform 205 may be implemented using instructions sets and/or other computer-readable code or data that is stored in one or more different computer readable media, which may include program and/or storage memory, including both volatile and/or non-volatile types, such as type(s) of random access memory (RAM), read-only memory (ROM), and flash memory. Instruction sets stored in such memory devices may be executed by one or more processes communicatively linked to memory devices, such as, but not limited to, one or more microprocessors, central processing units (CPU), digital signal processors (DSP), arithmetic logic units (ALU), general purpose processors (GPP), application specific integrated circuits (ASIC), network server devices, or the like, which are generally referred to herein as “processor(s)”.

While bidding platform 205 may be illustrated in FIG. 4 in terms of one or more different discrete modules (explained in further detail below), the arrangement shown is exemplary in nature only and may be varied in alternative embodiments. For example, two or more different modules may be combined together to form a composite module providing equivalent or similar functionality to each of the individual modules in aggregate. Alternatively, one or more of the modules shown may be split into plural modules that, in the aggregate, provide equivalent or similar functionality. Other modules not explicitly shown may also be incorporated into a bidding platform 205, either with or without alteration to existing module(s).

In some embodiments, bidding platform 205 may be configured and operable to perform one or more different functions either alone or in combination. These may include: management of campaign level bidding rules and constraints; interfacing with received requests for bids on impressions; matching of impressions with media buying rules; ranking of matched campaigns based upon corresponding bid prices; selection of media buying rule(s) with the highest bid(s); generation of bid response objects based on the selected media buying rule(s); sending bid response objects to supply-side requesters, such as exchanges, and logging of bids.

Accordingly, as shown in FIG. 4, a bidding platform 205 may include a number of different software or other modules, including a campaign manager 305, a data logger 310, a bid optimizer 320, and a rules interpreter 335. A number of different databases accessible to such software program(s) may also be included in bidding platform 205, including a real-time bidding (RTB) log database 315, a media buying rules (MBR) database 325, and a user database 330.

Campaign manager 305 may provide an interface for advertisers or their agents (or other demand side entities) into bidding platform 205 in order to input campaign parameters that will be used by bidding platform 205 to generate media buying rules. For example, advertisers may input any objectives and/or constraints (as well as modify or delete any previously input campaign parameters) for their advertising campaigns into bidding platform 205 using campaign manager 305. When a campaign is initiated (or is ongoing), bid optimizer 320 may generate media buying rule(s) for the campaign based on inputted campaign parameters and training datasets stored in RTB log database 315 by data logger 310. Once media buying rule(s) are generated, they may be stored in MBR database 325 and used by rules interpreter 335 and bidding server 340 to bid on incoming requests for bids on impression opportunities. User database 330 may store information relevant to customers and different supply side entities that rules interpreter 335 may use in generating bids based on selected media buying rules retrieved from MBR database 325. Bidding server 340 is configured to communicate with an ad exchange or other supply side entity conducting real-time auctions or otherwise supplying requests for bids to bidding platform 205.

For the duration of an ad campaign, events such as impressions, clicks, purchases, downloads, etc. may be logged into log files by ad servers or other suitably configured tracking servers. In some cases, different types of log files may be produced, such as impression logs, click logs, conversion logs, etc. For example, every time a user is exposed to an impression, a corresponding entry may be added to an impression log recording different information or data related to the impression. Additionally, every time an impression results in a conversion (such as a click, purchase or download), a corresponding entry may be added to a conversion log recording particular details of the conversion. In some cases, separate conversion logs may be generated for different types of conversions, e.g., a separate click log, purchase log, and download log.

In some embodiments, log file data generated by an ad or tracking server can be transferred to modeling and/or analytics servers for modeling and/or optimization or for any other purpose generally. Log files may be concatenated together (either physically or virtually in hard disk or memory). Subsets of an overall dataset may be used. Different events recorded in log files may also be assigned a weight, e.g., based on recency or the type of event corresponding the data

Log files may comprise data that were served using initial media buying rules and/or optimized buying rules as described herein, but may also include data relating to past or unrelated campaigns so as to provide sufficient training data sets for generation of initial media buying rules. Each logged event can further be augmented with data of the following sources: first party data (e.g., private advertiser data such as offline store sales data), second party data (e.g., private coop data from strategic partners), and/or third party data (e.g., data vendors such as BlueKai, Experian, Exelate, TargusInfo); derived variables over these data, such as conversion rate of category; recency data, e.g., how recent was a user at an advertiser's website or how recently was an ad viewed; frequency data, e.g., how often has a user interacted with this category of webpage or app; and velocity data, e.g., whether the user is increasing or decreasing its interactivity with this category of webpage or app; delta variables, such as difference in amount spent in period X and period Y; various mathematical functions of these variables such as log or squares, square-root etc; various functions of combinations of variables described above. Thus, each logged event can be augmented by any combination of resulting features as a result of applying any subset of these variable generation steps. In alternative embodiments, event-centric examples can be transformed to user-centric example, (e.g., where a user is a visitor to a webpage or app), where logfile event data, first party, second party, and/or third party data can be used to characterize a user using any of the above described features or variables.

Log files may be collected by data logger 310 in communication with ad or tracking servers and stored in RTB log database 315. In some embodiments, log files, or augmented versions of log files as described herein, may be divided into at least three file subsets, including first, second, and third datasets. A first dataset (“Dataset 1”) may be generated and used for filtering rule generation. A second data (“Dataset 2’) may be generated and used for media buying rule generation and selection. A third dataset (“Dataset 3”) may be generated and used for evaluation purposes, e.g., of media buying rules prior to or after deployment. Thus, Dataset 1 may be used to generate a set of filtering rules which encompass one or more of feature selection, feature removal, real-valued feature (input and target) discretization, and other processes conducted by a bid optimizer 320. Filtering rules generated based on Dataset 1 may then be applied to Datasets 2 and 3 to produce filtered versions of these datasets, which may then be used by bid optimizer 320 for media buying rule generation and selection, and for evaluation purposes, respectively.

Media buying rules generated by bid optimizer 320 are stored in MBR database 325 for retrieval by rules interpreter 335 for use in generating bids on incoming requests to bidding server 340. For example, an incoming request for bid may indicate different parameters or characteristics of an ad impression being called by a supply side entity. Rules interpreter 335 receives information concerning the incoming request for bid and accesses MBR database 325 to retrieve applicable media buying rules stored therein. Based on the retrieved information, rules interpreter 334 decides whether or not to respond to the incoming request and, if so, how much to bid (as indicated by the bid component of the media buying rule). For example, rules interpreter 335 may match the condition component of the stored media buying rules to corresponding data in the request for bid and select the highest ranking media buying rule stored in MBR database 325 to form the basis of a bid. Bidding server 340 may then transmit the bid to an ad exchange, real-time auction service, and the like.

In some embodiments, continuous or real-valued context variables may be discretized in order to facilitate optimization of media buying. For example, in statistics and machine learning, discretization (sometimes referred to as “quantization) refers to the process of converting or partitioning continuous attributes, features or variables into to discretized or nominal versions of the same quantities and is a form of binning, as in making a histogram. Discretization can be accomplished in different ways. For example, data may be discretized into partitions of K equal lengths/width (equal intervals) or K % of the total data (equal frequencies). Alternatively, continuous or real-valued context variables can be discretized using a percentile based approach where the data for each variable is sorted and assigned to sequential buckets, each bucket having an equal number of examples assigned. Alternatively, continuous data can be discretized using an MDL method, in which best bids are defined recursively by information gains. Other possibilities include CAIM, CACC, Ameva, and others. Some machine learning algorithms are thought to produce better models for discretization of continuous attributes.

Referring to FIG. 5, there is shown an example data log record 500, e.g., which is stored in RTB log database 315. Data log record 500 includes a plurality a data fields 505, 510, 515, 520, each such data field corresponding to a different variable representing a corresponding parameter or characteristic of a historical user impression with displayed content. Data field 505 in the data log record 500 corresponds to a target variable Y representing the user response to an impression. Different values for variable Y may be stored in data field 505, denoted by y₁, . . . , yₙ, which correspond to different possible responses to the impression. For example, a different value may be defined for a click, a purchase, a download, no impression, etc. In some cases, variable Y may be binary valued (0 or 1) corresponding to two different outcomes, e.g., response (conversion) or no response.

Data log record 500 also includes a plurality of additional fields 510, 515, 240 corresponding to different targeting (i.e., used to target) parameters or characteristics of an impression. Like variable Y, each additional variable X₁, . . . , X^{N} may take on different values that record different impression parameters. Thus, for example, variable X₁ may represent the sex of the customer and may be binary valued. As another example, a variable X₂ may be defined to reflect the age of the customer, if known, and can be discretely valued accordingly. As a further example, a variable X₃ may be defined to represent the publisher page category (news, sports), if known, and may be valued accordingly.

In general, any number of different data fields 510, 515, 520 may be defined in data log record 500 depending on how many different impression parameters are logged by ad or tracking servers. In some embodiments, not every defined variable will have a known value for each impression, e.g., because different user systems only make certain pieces of information available, might have cookies blocked. Thus, data log records stored in RTB log database may not be complete.

Some data fields 510, 515, 520 in data log record 500 may correspond to characteristics of the customer, while other data fields 510, 515, 520 may correspond to characteristics of a web page or application in which the impression opportunity was provided. For example, a genre of the website (sports, fashion, news, etc.) may be logged, if known. Some data fields in the datalog record may further correspond to different characteristics of the displayed content itself, including type (banner ad, pop-up, side-bar), location (top of webpage, bottom, etc.), and others. Still other data fields 510, 515, 520 in the data log record 500 may correspond to other parameters provided by and/or derived at least partly from first party data, second party data, and/or third party data.

Referring now to FIG. 6, bid optimizer 320 may include any number of different modules or sub-modules in order to generate media buying rules based on training datasets of data logs, as well as first party data, second party data, and/or third party data (such as data log record 500). For example, as shown, bid optimizer 320 may include a feature selector 345, a media buying rules generator 350, a bid calculator 355, and a bid refiner 360.

In some embodiments, feature selector 345 may process training data sets of historical user behaviour in order to identify different (generally plural) variables that can be used to predict future user responses to impressions. Rules generator 350 together with bid calculator 355 may be configured to generate different (generally plural) media buying rules based on the identified features by feature selector 345. The generated media buying rules may be of the form shown in equations (1) and (2) comprising condition and bid components. As explained further below, rules generator 350 may define the condition component of a media buying rule, while bid calculator 355 may generate raw values for the bid component. Optionally, bid refinement 360 may then be used to further optimize such bid values for the media buying rules based on different factors, e.g., campaign constraints and/or objectives supplied by advertisers. If not bid refinement is performed, then raw bid values generator by bid calculator 360 may be used as final bid values in media buying rules.

Referring now to FIG. 7, there is illustrated an example process performed by a feature selector (e.g., 345 in FIG. 6) for selecting features based upon which to generate media buying rules. According to the example process, one or more variables from a training set of data log records of historical user behaviour, e.g, interactions with impressions, may be selected from a plurality of different variables or features, such that the selected features have a predictive quality with respect to future user interactions with impressions opportunities. Other features having no or less predictive power may be discarded. Selected features may form the basis for one or more media buying rules, e.g., generated by a rule generator 350.

Predicted conversion rate can be defined according to equation (4) using conditional probabilities of different interaction with impressions given a certain context. In order to model a predicted conversion rate P(action|p, a, u), different techniques and approaches may be possible, which may generally be grouped into different categories. These include, for example, collaborative filtering approaches, predictive approaches, and evaluation approaches. In some broad sense, these approaches may also represent an attempt to understand and predict future user behavior based on a record of historical user behaviour (e.g., which can be generated from datalog files). Thus, evidence of past user impressions and the content in which the impressions occurred is used to construct a probability model of future positive impressions. This can be viewed as a form of implicit relevance modeling. In addition, certain hybrid models have been developed where predicted conversion rates are combined with empirical data counts using, e.g., Beta updating.

Studies have shown that advertising relevance may generally involve complex inference processes that extend beyond surface-form semantic models commonly used in traditional information retrieval and organic web search (typically unigram modeling with limited semantics such as the role of the n-gram in the query or sentence, e.g., a city or person's name). These inference processes may involve a complex interaction between the message or content contained within an ad creative (e.g., words, images, video), the target audience, the pitch level of the ad (to produce increases in brand awareness or to achieve other marketing objectives such as product sales), and user modeling. For example, if a consumer has already purchased a product, that consumer may not need further brand-based advertising; however, product sale advertisements may be of considerable interest to this particular consumer.

In machine learning and statistics, feature selection (sometimes also referred to as variable selection, feature reduction, attribute selection or variable subset selection) may denote a technique of selecting a subset of relevant features from a larger overall variable set so as to build robust learning model(s). Thus, feature selection may involve a reduction of the overall variable set to only a subset of the overall features that are of interest to the learning model(s). Feature selection may be useful in analyzing data from many experimental techniques in domains that are associated with a large number of measured variables (features), but a generally low number of samples of those variable. By removing mostly irrelevant and/or redundant features from the overall data set to arrive at only the subset of features of interest, feature selection may help improve the performance of learning model(s) in a number of different respects. For example, these may include: alleviating negative effects of dimensionality, enhancing generalization capability, increasing the speed of the learning process, and improving model interpretability.

In some cases, feature selection techniques may fall into one of two different categories: feature ranking and subset selection. Feature ranking may involve ranking different features using a suitable metric and eliminating all features from the overall data set that do not achieve an adequate score (the remaining subset is then utilized). On the other hand, subset selection may involve searching the set of possible features for an optimal subset. Thus, while feature ranking may generally consider the significance of features individually, subset selection may involve an evaluation of feature subsets as groups for suitability.

Subset selection algorithms can further be categorized as Wrappers, Filters, or Embedded, as well as others, potentially. Wrappers generally employ a search algorithm to search through the set of possible features and evaluate each possible subset in terms of a model run on that subset. Wrappers can be computationally expensive and, in some cases, may involve a risk of over fitting to the model. Filters can utilize a subset search that is similar to Wrappers; however, instead of evaluating each subset against a model, a simpler filter is evaluated. Embedded techniques are embedded in and specific to a model (e.g., decision tree learning incorporates feature selection as part of the learning algorithm). For example, some search approaches use greedy hill climbing, which iteratively evaluates a candidate subset of features, but then modifies the subset and evaluates the new subset to determine if it provides an improvement over the old subset. This process is repeated until all features are examined in the hill-climbing manner.

In accordance with the described embodiments, suitable feature ranking approaches can be based on scores computed using correlation and/or mutual information. For example, such scores can be computed for each of a plurality of candidate features (or feature sets) and a desired output category, e.g., which may be defined in terms of a discrete dependent variable.

In some embodiments, mutual information may be computed as a symmetric, non-negative measure of common information between two variables. Thus, for two independent variables, computed mutual information will be zero; for two dependent or correlated variables, non-zero valued. In the latter case, the computed mutual information may also increase not only with the degree of dependence, but also according to the entropy, of the variables. As one example, mutual information between a discrete input (or independent) variable X and a discrete target (or dependent) variable Y can be defined as follows:

$$MI ( X , Y ) = {\sum }_{y ∈ Y} {\sum }_{x ∈ X} p ( x , y ) log ( \frac{p ( x , y )}{p ( x ) p ( y )} ) , \qquad ( 6 )$$

where p(x,y) represents the joint probability distribution function of variables X and Y, and p(x) and p(y) represent the marginal probability distribution functions of variables X and Y, respectively. In the case of continuous random variables, equation (6) can be rewritten as follows:

$$MI ( X , Y ) = {\int }_{Y} {\int }_{X} p ( x , y ) log ( \frac{p ( x , y )}{p ( x ) p ( y )} ) d x d y , \qquad ( 7 )$$

where p(x,y) now represents the joint probability density function of variables X and Y, while p(x) and p(y) represent the marginal probability density functions of variables X and Y, respectively.

Mutual information MI(x,y) may provide a measure of the extent to which a context variable is associated with a target variable. In generally, context variables X that exhibit high mutual information values with respect to a target variable Y are potentially good discriminators for impression opportunities that are more likely to result in conversions than other impression opportunities defined by different context variables. On the other hand, low valued (e.g., zero or close to zero) mutual information between a given context variable and a target variable may suggest independence or relative independence between the two variables. Accordingly, in some embodiments, context variables exhibiting high mutual information values may be selected by feature selector 345, while those variables exhibiting low mutual information may be eliminated from the impression model.

Given a training database, e.g., based on datalogs of historical user interaction supplied to a bidder service and stored in an RTB database 315 (FIG. 6), mutual information may be computed for each feature in an input feature vector using the approach(es) described herein. Features whose mutual information value is computed to be less than a predetermined threshold may be removed from the input feature vector. Alternatively, the input feature vector may be reduced to a predetermined number of features remain by considering only the features having the highest mutual information (and eliminating the others). Mutual information measures nonlinear relationships, and can be extended to sets of features, making it suitable for greedy selection schemes in accordance with the described embodiments.

The estimation of mutual information for feature selection may in some cases be subject to certain inaccuracies e.g., which may be due to noise, small sample size, sub-optimal choice of parameters for the estimator, etc. The choice of a threshold above which a feature will be considered useful can sometimes be difficult to make. Accordingly, in some embodiments, use of a permutation test to assess the reliability of the estimation can be effectively utilized. Such permutation test may employ a non-parametric hypothesis test in order to select the most informative/predictive variables.

According to a permutation test, the predictive power of a context variable X for a given target variable Y may generally be inversely proportional to the p-value of a null-hypothesis test defined, for example, as follows:

H₀:p(Xⱼ|Y=0)=p(Xⱼ|Y=1), (8)

based on a test statistic θ, such as mutual information MI(X,Y) as defined by equations (6) or (7) above. In statistical hypothesis testing, the p-value represents the probability of obtaining a test statistic at least as extreme as the statistic that was actually observed assuming that the null hypothesis is true (e.g., that there is no correlation between variables). The null-hypothesis condition defined according to equation (8) therefore assumes that the probability of a given context variable Xⱼ being a certain value has no correlation to the variable of the target variable Y. Thus, low p-values suggest that the observed test statistic was, in fact, not likely to occur under the null-hypothesis test (which can therefore be rejected in respect of those variables).

While mutual information MI(X,Y) may be used as a suitable test statistic θ in some embodiments for performing binary classification, other distance measures of predictive power may be possible as well. For example, difference in sample means may be defined as follows:

r_{M}(X)=E[X|Y=0]−E[X|Y=1], (9)

where E[ . . . ] represents expected value. Alternatively, a symmetric variant of the Kullback-Leibler distance, referred to as J-measure, may be defined as follows:

$${r}_{j} ( X ) = {\sum }_{x} [ \begin{matrix}p ( X = x \vert Y = 0 ) - \\ p ( X = x \vert Y = 1 )\end{matrix} ] \cdot {log}_{2} \frac{p ( X = x \vert Y = 0 )}{p ( X = x \vert Y = 1 )} . \qquad ( 10 )$$

As a further option for a distance measurement value, information gain may be defined as follows:

$${r}_{IG} ( X ) = {\sum }_{x} {\sum }_{y} p ( X = x \vert Y = y ) \cdot {log}_{2} \frac{p ( X = x \vert Y = 0 )}{p ( X = x ) p ( Y = y )} . \qquad ( 11 )$$

As a still further alternative, a chi-squared statistical measure may be defined as follows:

$${r}_{CHI} ( X ) = {\sum }_{x} {\sum }_{y} \frac{{[ p ( X = x \vert Y = y ) - p ( X = x ) \cdot p ( Y = y ) ]}^{2}}{p ( X = x ) \cdot p ( Y = y )} . \qquad ( 12 )$$

Any of mutual information, difference in sample means, J-measure, information gain, and chi-squared may be used in different embodiments as a test statistic θ. These types of feature selection can be equally applied to multi-valued discrete variables with loss of generalization. For predictive problems, e.g., problems with continuous dependent variables, either correlation, discretization of continuous target and context variables, or both, in conjunction with the methods described herein may be utilized.

In accordance with the described embodiments, a permutation test (also referred to sometimes as a randomization test, re-randomization test, or an exact test) is a type of statistical significance test in which the distribution of the test statistic under the null hypothesis defined according to equation (8) above is obtained by calculating all possible values of the test statistic θ under rearrangements of the labels on the observed data points. If it is determined that the applied labels are exchangeable under the null hypothesis, then the resulting tests yield exact significance levels. Confidence intervals can then be derived from the tests. A permutation test may work for a binary classification problem as follows.

At 705, a training set (e.g., Dataset 1) is partitioned into two classes of samples comprising one class for each binary value of a target variable Y. For example, the training set may be partitioned into m class 1 samples and n class 2 samples. The class 1 samples may correspond to a value (e.g. 1) of the target variable Y corresponding to conversions, while the class 2 samples may correspond to a different value (e.g., 0) for the same variable corresponding to no response. A permutation test for feature selection may look at each feature individually.

At 710, a test statistic θ, such as mutual information MI(X,Y), may be calculated for the input feature. However, all of the test statistics described herein, as well as others potentially, may be used in alternative embodiments instead of mutual information MI(X,Y).

At 715, data for the context variable X may then be randomly permuted and partitioned into two sets as defined above, e.g., one such set being of size m and the other being of size n, corresponding to class 1 and class 2, respectively. Thus, partitioning of data sets in this manner will take as given that the same outcomes (number and type) for a target variable occurred (e.g., same number of impressions versus no impressions), but randomly assign values to context variables in order to determine a random distribution of the test statistic θ in accordance with the null-hypothesis.

For each permutation, at 720, the test statistic (denoted now θₚ) may be calculated based on a given permutation p of the context variable X. Depending on the computational complexity of the problem, permutation may be repeated (indicated by dashed loop in FIG. 7) over all possible partitions of the feature into two sets of order m and n or, alternatively, a random subset of these (e.g., to reduce computational load). The latter approach is known sometimes as the Monte Carlo permutation test.

At 725, a distribution of the test statistic θₚ may be generated from the different computations of the test statistic θₚ. Based on the generated distribution, at 730, the p-value that the observed test statistic θ arose from a random partition of the feature may be computed. The null hypothesis states that samples from each class come from the same underlying distribution (the target variable Y is independent of the input feature X and therefore has no predictive power for the target variable).

At 735, the feature may either be selected or rejected based on the computed p-value. For example, if the p-value indicates that the observed test statistic θ was not likely to have been randomly achieved, then the null hypothesis may be rejected for that input feature X and it may be concluded that the input feature X and the target variable Y are correlated. Otherwise, the p-value is large, the null hypothesis may be confirmed and the feature rejected.

A permutation test such as is described herein may be repeated for all features in the input feature vector and then the subset of features used for prediction can be selected based on the outcomes of the permutation tests. For example, as noted herein, in some cases all features with a computed p-value that is less than a predefined threshold (e.g., ε=0.05) may be selected. Alternatively, a predetermined number N of features having the lowest p-values may be selected (regardless of whether each selected feature has a p-value less than a threshold e).

Referring now to FIG. 8, there is shown an example table 800 that illustrates the various steps performed in method 700 of FIG. 7. As seen, table 800 includes a column 805 defining a class of data record (e.g., class 1 or class 2), and a column 810 defining a number or ID of each data record. Column 815 shows the real distribution of target variable Y sorted by outcome. Thus, all data records corresponding to Y=1 are assigned to class 1 and all other data records (because Y is binary valued) are assigned to class 2. Column 820 includes values for a given context variable Xⱼ.

The remaining columns 825 in table 800 correspond to different permutations of context variable Xⱼ, which are denoted by X_{P1}, X_{P2}, X_{P3}, and X_{PN}. Each different column corresponding to a permutation of Xⱼ includes the same number and type of outcomes (e.g., 0 or 1), but randomly distributed between different data records 1 . . . N. Row 830 includes calculated values of the test statistic, including the test statistic θ calculated for the real distribution of the context variable Xⱼ, as well as test statistics θ_{P1}, θ_{P2}, . . . , θ_{Pn}, corresponding to each different permutation Pⱼ, which are used to generate a distribution of the permuted test statistic θ_{P}.

Referring now to FIG. 9, there is shown an example distribution 900 of the permuted test statistic θ_{P}. The null hypothesis distribution, i.e. the distribution of the test statistic θ_{P} after randomization of context variable Xⱼ is shown in grey at 905. The vertical line 910 denotes the test statistic θ as observed for context variable Xⱼ, i.e., which is calculated based on the actual distribution of Xⱼ. As shown, the test statistic has a very small p-value (the area covered by the null hypothesis distribution to the left of vertical line 910 is small compared to the area covered by the part of distribution 905 left of its median value where distribution 905 is at maximum height). Accordingly, FIG. 9 demonstrates that the relationship between the two variables Xⱼ and Y was likely not due to chance, but rather that the target variable Y is dependent on context variable Xⱼ. It may therefore be determined that variable Xⱼ is predictive of variable Y.

Referring now to FIG. 10, there is illustrated an example process 1000 performed by a rules generator (e.g., 350 in FIG. 6) for generating media buying rules based upon one or more features selected by a feature selector (e.g., 345 in FIG. 6). The media buying rules generated may in some cases represent target scenarios, defined in terms of one or more selected features, where ads or other content corresponding to a given campaign can be displayed. The media buying rules may generally be defined so that the target scenarios in which it has been determined that customers exposed to the ad impressions are more likely to generate conversions or other action on the impressions.

Media buying rules can be generated by processing data set(s) extracted and derived from log files of past user behaviour, e.g., RTB log database 315, as well as first, second, and/or third party data. For example, in some cases, media buying rules can be generated using the filtered version of Dataset 2 (referred to subsequently as Dataset 2 for simplicity), and result in a list of targets (or the condition component of a media buying rule) for media buying rules being generated as follows. As individual records in dataset 2 are composed of discrete variables, they can be grouped by feature values, i.e., rows sharing common properties are combined and summarized using an aggregate function. In performing this operation, an aggregate function can be applied to each group.

In some embodiments, data records can be aggregated according to conversion rate for an ad, e.g., all data records having the same feature values can be grouped together. As noted above, conversion rate for an ad corresponds to the number of corresponding conversions divided by the total number of corresponding impressions in Dataset 2, which is an equivalent calculation to the maximum likelihood estimate (MLE) of the conversion rate. Smoothing, for example, Bayesian-based smoothing, can also be applied in some cases.

For example, at or around the time of launching a campaign on a new traffic source, e.g., a new page, some form of exploration versus exploitation can be performed. Because the campaign is still relatively new, data records may be sparse and media buying rules may not yet be optimized. Thus, there may be a compromise between gathering new information in order to build or refine learning models (exploration), and spending campaign resources by deploying existing media buying rules (exploitation).

One approach that can be used is to impose a beta prior on a target variable Y (e.g., conversions), derived from an aggregated variable Z that is naturally available from a media buying rule-based hierarchy and, therefore, will typically include much denser data than the still sparsely populated conversion Y corresponding to media buying rule's target X. A suitable smoothing function may be defined as follows:

y˜Beta(λy_{z(x)}+1,λ(1−y_{z(x)})+1) (13)

where y_{z(x)} denotes the conversion rate for a parent of the media buying rule X, such as for the campaign (over all media buying rules for the campaign), or for the advertiser who is running this campaign, or for all advertisers, or for a category of ads, and λ is the smoothing factor. The MAP estimate of the conversion rate of media buying rule X is then defined as follows:

$${y}_{x}^{Map} ← \frac{{x}_{x} + λ {y}_{z ( x )}}{{n}_{x} + λ} . \qquad ( 14 )$$

In equation (14), z(x) represents a mapping function from X to an aggregated level Z, e.g., the all rules-rule pair, while nₓ and xₓ denote the number of impressions for media buying rule X and the number of conversions for the media buying rule X.

According to a Bayesian-based smoothing, there is provided a priori observed λ y_{z(x)} conversions derived from λ impressions with feature vector X before any actual impressions matching rule X are observed. The parameter λ·controls smoothing strength, which in some cases may provide a reasonably strong smoothing for those X's with zero conversions denoted by sx=0, while at the same time being conservative with the X's in terms of sufficiently positive feedbacks, especially where the number of conversion is large Xₓ>>0.

In some embodiments, conversion probabilities for media buying rules may be estimated based on impression and conversion events using a logistic regression model as follows:

$$Pr ( Conversion ) = \frac{1}{1 + Exp ( - {\sum }_{i = 1}^{n} {w}_{i} {x}_{i} )} \qquad ( 15 )$$

In equation (15), the probability of a positive impression Pr(Conversion) is modeled using training data of the form <Impression, Conversion> where: impression denotes impression, user, publisher, ad, and advertiser features, as described herein, and conversion is the target variable Y. This model can be used to predict conversion rates for media buying rules which lack data. In some embodiments, the predicted conversion rates can be de-biased using techniques from statistics and machine learning. In some embodiments, any subset of the above generated conversions rates can be combined using a mathematical function such as a linear weighted combination where the weights can be optimized using a maximum likelihood-based optimization algorithm or optimization techniques.

At 1005, a plurality of different media buying rules are defined corresponding to one or more selected features of impressions. The number of media buying rules defined may be set by the number and dimensionality (cardinality) of the selected features according to cross-product. So, for example, three different variables X₁, X₂, and X₃, each being binary valued, will generate a total of 8 different buying rules. Each different media buying rule corresponds to a unique set of values within all sets of values for selected variables.

At 1010, a score is computed for each defined media buying rule. For example, conversion rate (defined as conversions over impressions) may provide a suitable score in some embodiments. To calculate conversion rate, data records in a data log (e.g., Dataset 2) having variables valued as in a different media buying rule may be swept in order to count a total number/frequency of conversions and impressions. A ratio of these two counts may then provide the calculated score.

In some cases, media buying rules or scenarios may represent a hierarchy different impressions, organized in terms of expected return, which can be bid on during a campaign. Each rule or scenario corresponds to a different type of impression that is characterized by a different context (as represented by different discrete values of a variable set, e.g., different binary values of variables of X₁, X₂, and X₃). Predicted conversion rate provides a score that may reflect expected return during a campaign, but other scores may be suitable as well.

At 1015, media buying rules are aggregated (grouped) and ordered according to a score, e.g., conversion rate. For example, the variables may be grouped using an SQL group by statement executed over a logfile (e.g., Dataset 2) as follows:

SELECT A, B, C, COUNT(*)/totalImpressions AS ConversionRate

FROM Dataset2

GROUP BY A, B, C

ORDER BY ConversionRate DECREASING;

Execution of such a group by command yields media buying targets (see FIG. 11), which are sorted row-by-row in decreasing order of score (conversion rate).

At 1020, a subset of all media buying rules may then be selected based on score (with the remainder of all media buying rules being discarded). For example, in some cases, a predetermined number (e.g., 3) or percentage (e.g., 20%) of the highest scoring media buying rules may be selected.

Alternatively, to select a subset of all media buying rules, a minimum threshold score may be computed and all media buying rules having a score greater than or equal to a minimum threshold score may be selected (with all others being discarded). In some cases, the utilized threshold score can be the global (e.g., aggregate) conversion rate of all media buying rules defined by the selected variables (in Dataset 2). Selected media buying rules may then have bid prices computed and, optionally, refined as explained below.

In some embodiments, for each media buying rule selection, each rule may be associated with an upper confidence bound as follows:

Score_{UCB}=ConversionRate+NumOfSTD×STD (16)

where conversionRate is the maximum likelihood estimate of conversions of the media buying rule as defined herein, STD is the stand error of the conversion rate, and NumOfSTD is the number of standard deviations, e.g., one. This Score_{UCB} can then be used to sort media buying rules. Subsequently, thresholding approaches as defined herein can be used to select rules from this sorted list of media buying rules.

Referring now to FIG. 11, there is shown an example table 1100 that illustrates the various steps performed in method 1000 of FIG. 10. As seen, table 1100 includes a column 1105 contain a rule number or ID for each media buying rule in the set of all media buying rules. In this example, 8 different rules are identified in 8 different rows, which corresponds to the cross-product of 3 binary valued variables X₁, X₂, and X₃. Columns 1110 indicate the respective values for variables X₁, X₂, and X₃ that defined each rule included in table 1100. For example, rule 3 is defined by a vector {X₁=1, X₂=0, X₃=1}. Similarly rule 6 is defined by a vector {X₁=0, X₂=0, X₃=1}.

Column 1115 in table 1100 shows a conversion rate for each rule computed by sweeping over all data records in a log file (e.g. Dataset 2) and counting conversions and impression. For example, 100 data records for impressions corresponding (i.e., having the same context) as defined by Rule 2 were counted, of which 10 of those 100 data records also recorded a conversion. Thus, column 1115 lists a conversion rate of 10/100 for Rule 2. A corresponding score of 0.1 is recorded for rule 2 in column 1120.

Column 1125 records a decision (select or reject) for each rule included in table 1100. Row 1130 represents a cut-off threshold for media buying rules, such that all rules included above row 1130 are selected, while rules located below row 1130 are rejected. The cut-off threshold defined by row 1130 is calculated as the aggregate score (conversion rate) of all media buying rules included in table 1100 and is equal to 0.09. This aggregate score is calculated as 45 total conversions (15+10+10+4+4+1+1+0) divided by 500 total impressions (100+100+100+50+50+20+50+30). So, in this example, all media buying rules having scores equal to or greater than 0.09 (i.e., rules 1, 2, and 3) are selected.

Referring now to FIG. 12, there is illustrated an example process 1200 performed by a bid calculator (e.g., 355 in FIG. 6) for computing raw bid prices for media buying rules generated by a rules generator (e.g., 350 in FIG. 6). The computed raw bid prices may be based, at least partly, on expected conversion rate, as well as other advertiser supplied information, such as objectives and/or constraints for an ad campaign. For example, advertiser agreed cost per action or cost per impression may be used in computing raw bid prices for media buying rules. As explained further below, raw bid values may be smoothed or refined in order to provide still further cost-optimization.

As explained above, selected media buying rules or scenarios may be sorted (e.g., by a rules generator 350) in descending order of score (conversion rate), which in some embodiments may correspond to a maximum likelihood estimate of the conversion probability or smoothed versions of the conversion probability. A corresponding bid price may be computed for each selected media buying rules using windowing, optionally, which is followed by data smoothing. One technique for windowing media buying rules is as follows.

At 1205, one or more parameters used for windowing media buying rules may be initialized at user-defined values. For example, any or each of the following parameters may be initialized: Rev_TARG (Revenue per Target or conversion), Min_TARG (Minimum Number of targets or conversions in a bucket), OFF_TARG (Off-set per bucket), and Min_Price (Minimum CPM for a bucket). Use of these parameters in process 1200 is explained further below.

At 1210, a window is initialized starting with a highest ranking media buying rule in the table and ending with the media buying rule lower down in the table such that the cumulative sum of targets (e.g., conversions) included in the media buying rules exposed by the window is greater than or equal to parameter Min_TARG. The media buying rules within the initialized window are recorded as Bucket #1. If the number of targets (or conversions) included in the highest ranked media buying rule is already greater than or equal to parameter Min_TARG, then Bucket #1 will only include such highest ranking media buying rule; otherwise additional media buying rules will be included, in decreasing rank, until enough media buying rules are included that the Min_TARG condition is satisfied.

At 1215, an average bid price for all media buying rules included in the initial bucket is calculated. For example, the average bid price may be calculated as follows:

$${Bid}_{i} = Rev\_TARG \cdot \frac{{\sum }_{{W}_{i}} Targets}{{\sum }_{{W}_{i}} Impressions} \qquad ( 17 )$$

where Bidᵢ represents the calculated bid value for the i^{th} window, and the number of targets and impressions are summed over all media buying rules included within window Wᵢ. The bid price calculated according to equation (17) may be viewed as a raw CPM and is assigned to the initial bucket.

At 1220, the window is advanced down the table of media buying rules by the parameter OFF_TARG. Thus, for example, the starting point of the window is moved down by the minimum number of media buying rules such that the new start of the window is offset from the previous starting point by at least the OFF_TARG number of targets (conversions). After a new starting point for the window is determined, an ending point is determined. For example, as described in 1210, the ending point may be determined such that the start and end points of the new window are separated by at least Min_TARG number of targets. Alternatively, the ending point of the window may be determined as the lowest ranking media buying rule in the table, if reached, regardless of whether or not the Min_TARG condition is satisfied. All media buying rules exposed by the new window are recorded as a new Bucket with a sequentially larger ID number than the previous bucket, for example.

At 1225, a raw CPM for the currently exposed bucket is calculated, as described at 1215, using equation (17). The calculated CPM is then assigned to the currently exposed bucket.

At 1230, it is checked whether or not the window has reached the end of the table of media buying rules. If it is determined that the window has not reached the end of the table, then the method 1200 branches back to 1220 for advancement of the window to a new bucket and calculation of a corresponding raw CPM for the currently exposed bucket. In some cases, the termination condition for method 1200 may be that the ending point of the window has reached the lowest ranking media buying rule in the table.

On the other hand, if it is determined that the window has reached the end of the table, then method 1200 branches to 1235 and a CPM value is determined for each media buying rule based on the raw CPM values calculated for each of the defined buckets. The CPM values, known as the bid for the rule with zero margin, for media buying rules can be generated from the raw CPM values as follows. For each media buying rule, the raw CPM values for each bucket in which that media buying rule defines a set of raw CPM values. In one embodiment this set of raw CPMs may be summed together and divided by the total number of buckets in which that media buying rule is included. The results in an average raw CPM being assigned as the bid for the rule. In some embodiments, a min value of this set of values is assigned to the media buying rule. Alternatively, an average or weighted average value, e.g., which is based on conversion rate of the rule, may be assigned to the media buying rule.

Referring now to FIG. 13, there is shown an example table 1300, corresponding to an ad campaign where the advertiser has agreed to pay $2 per action. This figure illustrates the various steps performed in method 1200 of FIG. 12. As seen, table 1300 includes a column 1305 containing a rule number or ID for each media buying rule included in the table (of which there are 8 in this example). Columns 1310 present a corresponding conversion rate, score, cost per action (CPA), and gross revenue per impression (GRPI) for a first bucket. Columns 1315 and 1320 present the same quantities for a second and third bucket, respectively. Column 1325 indicates which buckets each media buying rule is included within, and column 1330 presents a min raw CPM bid price for each media buying rule.

In this example, buckets #1, #2, and #3 are generated through windowing of media buying rules table 1300 using the following initialized parameters: Rev_TARG=$2 per action, Min_TARG=7 conversions, OFF_TARG=2 conversions, and Min_Price=$0.26. With these parameter values, bucket #1 includes media buying rules 1 through 3, bucket #2 includes media buying rules 2 through 6, and bucket #3 includes media buying rules 4 through 7. The width of each window is at least 7 conversions, and each window is offset by at least 2 conversions. With these windows, raw CPM values of $0.35, $0.117, and $0.028 are calculated for the first three buckets, respectively, with bids being set using the minimum raw CPM of assigned buckets (described above) for 1330.

Alternatively, in some embodiments, the bid price for each media buying rule may be determined based on cost per action and predicted conversion rate. For example, bid prices may be determined this way as follows:

Bid=CPA×ConversionRate, (18)

where ConversionRate is computed as described herein (e.g., maximum likelihood estimate of the conversion rate, or a smoothed conversion rate using, for example, a Bayesian smoothing technique), and CPA denotes the cost per conversion that an advertiser has agreed to pay when a user interacts with a displayed ad and converts.

Referring now to FIG. 14, there is illustrated an example process 1400 performed by a bid refiner (e.g., 360 in FIG. 6) for modifying and/or refining raw bid prices for media buying rules computed by a bid calculator (e.g., 355 in FIG. 6). In accordance with the described embodiments, bid smoothing for media buying rules can be accomplished as follows.

At 1405, cheap inventory can be removed, for example, so as to avoid overloading a bidding platform programmed to bid automatically on all incoming requests for bids. In some cases, inventory thinning can involve removal of all rules having Bid prices below a Min_Price (previously initialized to a user-defined value).

At 1410, a margin can be applied so that each bid value is adjusted by the margin. For example, a 30% margin results in each bid price being scaled by a factor 0.7.

At 1415, bid prices can be capped at pre-defined limit values. For example, bid prices can be capped at about 3× to 5× the CPM of the learning datasets.

At 1420, it can be determined if all calculated bid prices in descending order or media buying rule are also in descending order of bid price. If a lower ranked media buying rule has a higher bid price than a higher ranked media buying rule, then the price of the lower ranked (but higher valued) media buying rule can be reduced to the level of the higher ranked (but lower valued) media buying rule. This may ensure that bid prices for all media buying rules are strictly decreasing in order of decreasing rank.

At 1425, it can be determined if the difference between bid price of adjacently ranked media buying rules exceeds a predetermined percentage and, if so, the bid prices can be adjusted so as to not exceed such percentage. For example, a maximum of 12.5% change can be defined. Thus, starting with the lowest ranked media rule and ascending up the list, each media buying rule can be capped at the pre-determined percentage difference as applied to the next lowest ranking media buying rule. For example, the bid value for media buying rule 3 cannot be 12.5% greater than for media buying rule 4. Bid prices can then be replaced with the adjusted values.

At 1430, the bid prices associated with each media buying rule can be further adjusted using one or more different adjustment rules, as applicable. For example, the following rules may be applied:

If a scenario accounts for more than X % of the entire impressions log file, then the associated bid price is multiplied by a factor A, where A is a real number; and/or

If the value of one of the variables in a media buying rule is blank/null, then the bidprice is multiplied by a factor M.

The above description is meant to be exemplary only, and one skilled in the art will recognize that changes or variations may be made without departing from the scope of the embodiments disclosed herein. Accordingly, the scope of the invention is to be defined solely by the appended claims, giving due consideration to applicable rules and principles of construction, such as the doctrine of equivalents and related doctrines, which may be utilized so as to understand the full scope and meaning of such claims as is consistent with the intentions expressed or otherwise implied within this disclosure.

What is claimed is:

1. A system for generating data representing parameters useful for causing a processor to identify content to be displayed on a graphical user interface, the system comprising the same or another processor and stored machine-readable instructions configured to cause the processor to:
parse stored data to identify input patterns associated with a plurality of historical user interactions with displayed content on input/output interfaces, the stored data representing one or more attributes of the plurality of historical user interactions, and the identified input patterns defined in terms of two or more correlated variables;
based at least partly on the identified input patterns, generate data useful in implementing one or more media buying rules useful on a bidding platform for obtaining authorization to provide selected display content data to one or more client systems requesting the same or other selected content for display; and
route the generated data useful in implementing the one or more media buying rules to a bid generation engine associated with the bidding platform.

2. The system of claim 1, wherein the one or more attributes comprises input control commands used in navigation of displayed interactive content.

3. The system of claim 1, wherein the one or more attributes comprises characteristics of the input/output interfaces.

4. The system of claim 1, wherein the one or more attributes comprises characteristics of the content being displayed.

5. The system of claim 1, wherein the one or more attributes comprises characteristics of a user manipulating the input/output interfaces.

6. The system of claim 1, wherein each of the media buying rules comprises:
a conditions component specifying a corresponding one of the identified input patterns; and
a bid component specifying a bid price determined based on a pre-determined cost per action and a predicted conversion rate associated with the corresponding one of the identified input patterns.

7. The system of claim 1, wherein the processor comprises:
a bid optimizer configured to generate the one or more media buying rules based on one or more training data sets stored in a database of data logs and comprising data records of historical interactions with user interfaces.

8. The system of claim 7, wherein the bid optimizer is configured to augment the one or more media buying rules with at least one of first party data, second party data and third party data.

9. The system of claim 7, wherein the bid optimizer comprises:
a feature selector configured to process data logs of historical interactions with user interfaces and to determine features of the historical interactions that have a predictive quality of future interactions.

10. The system of claim 9, wherein the feature selector is configured to:
calculate a test statistic defined between a target variable and at least one context variable recorded in the data logs;
permute the at least one context variable to generate a plurality of different variable permutations;
for each generated permutation of the at least one context variable, calculate a permutation test statistic between the target variable and that permutation of the at least one context variable to generate a plurality of permutation test statistics;
generate a distribution of the permutation of test statistics; and
select or reject the at least one context variable based on a feature of the generated distribution.

11. The system of claim 10, wherein the test statistic comprises mutual information determined between the target variable and the at least one context variable.

12. The system of claim 10, wherein the test statistic comprises a difference in sample means determined between the target variable and the at least one context variable.

13. The system of claim 10, wherein the test statistic comprises a J-measure determined between the target variable and the at least one context variable.

14. The system of claim 10, wherein the test statistic comprises information gain determined between the target variable and the at least one context variable.

15. The system of claim 10, wherein the test statistic comprises a chi-squared statistical measure determined between the target variable and the at least one context variable.

16. The system of claim 10, wherein the feature of the generated distribution comprises a p-value of the determined test statistic.

17. The system of claim 16, wherein the feature selector is configured to select the at least one context variable if it is determined that the p-value is less than a pre-determined threshold.

18. The system of claim 9, wherein the feature selector is configured to partition the data logs into two or more classes of data logs based on a value of the target variable.

19. The system of claim 7, wherein the bid optimizer comprises:
a rules generator configured to generate a plurality of media buying rules from a plurality of variables representing features of historical interactions with user interfaces.

20. The system of claim 19, wherein the rules generator is configured to:
define a plurality of potential media buying rules based on the plurality of variables, each of the plurality of potential media buying rule defined by a corresponding set of values for the plurality of variables;
for each of the plurality of potential media buying rules, compute a corresponding score value used to rank the plurality of potential media buying rules; and
based on the corresponding score value, select a subset of the plurality of potential media buying rules as the plurality of media buying rules.

21.-87. (canceled)
